(19) United States
(12) Patent Application Publication
(10) Pub. No.: US 2011/0004852 A1
(43) Pub. Date: Jan. 6, 2011

(54) Electronic Medical Record System For Dermatology

(76) Inventor: Jonathon David Baugh, Ypsilanti, MI (US)

Correspondence Address: JELIC PATENT SERVICES, LLC, 2922 MARSHALL ST, ANN ARBOR, MI, 48108, US

(21) Appl. No.: 12/496,583

(22) Filed: Jul. 1, 2009

(51) Int. Cl. G06F 3/048

(52) U.S. Cl. 715/862

(57) ABSTRACT

The disclosure provides an electronic medical records system for dermatology. The electronic medical records system uses visual workflow methods instead of text based methods. Health professionals are able to identify skin areas and graphically record skin locations in a template. These locations in the template are a visual representation of the patient's condition. The locations are linked to identifiers which may include data and information.

### BACKGROUND OF THE INVENTION

Currently, there is a shift from paper medical records to electronic medical records (EMR). Recent legislation, the American Recovery and Reinvestment Act of 2009, has facilitated this shift.

### BRIEF SUMMARY OF THE INVENTION

The disclosure provides an EMR system for dermatology. The EMR system uses visual workflow methods instead of text based methods. Health professionals are able to identify skin areas and graphically record skin locations in a template. These locations in the template are a visual representation of the patient's condition. The locations are linked to identifiers which may include data and information.

The identifiers enable a health professional to evaluate and manage patient care. The identifiers are tied to menu trees. The menu trees enable the health professional to rapidly record common ailments while also allowing flexibility for uncommon ailments. The identifiers and menu trees may be accessed concurrently with the visual representation in the template.

Patient evaluations are integrated with patient illness management. The health care professional is able to review past history, update the history, identify possible treatments, order prescriptions, and add other miscellaneous information. The EMR system for dermatology enables the health care professional to record all relevant aspects of a patient visit in a fast, accurate, and convenient way.

### BRIEF DESCRIPTION OF THE DRAWINGS

FIG. 1 is a diagram which compares SOAP to OSAP.

FIG. 2 is a screen shot which shows a new patient encounter.

FIG. 3 is a screen shot which shows multiple skin conditions from a patient encounter.

FIG. 4 is a screen shot which shows a mouse-over popup with the details of a particular skin condition.

FIG. 5 is a screen shot which shows an edit screen for a skin growth.

FIG. 6 is a network diagram.

FIG. 7 is a flowchart illustrating a method for providing patient services.

FIG. 8 is a flowchart illustrating a method for recording a skin condition.

### DETAILED DESCRIPTION OF THE INVENTION

This disclosure describes a novel EMR system for dermatology (herein referred to as the system). The system contrasts with competing products in a number of ways. From conception, the system is designed for dermatology. Hence, it is not a general product modified to meet the requirements of dermatology.

For the purposes of this disclosure, a dermatologist is a health professional who specializes in treating the skin.

One advantage of the system is the overall workflow. Competing systems typically use a Subjective-Objective-Assessment-Plan (SOAP) method for workflow. This is the way that medicine is generally practiced. In contrast, dermatologists typically use an Objective-Subjective-Assessment-Plan (OSAP) method for workflow. Therefore, the system is designed to compliment an OSAP workflow method.

The first step in the OSAP workflow method is the objective phase. In this phase, the dermatologist makes an objective analysis of the patient. The EMR system for dermatology assists the dermatologist in a number of ways.

The system initially provides a graphical interface with templates for different skin locations. For example, one template shows skin locations on the front side of the head/neck area. The graphical interface allows the dermatologist to click-on a location which has a location specific address. The dermatologist may then enter a skin condition for the address. The system creates an identifier which corresponds to the address. Hence, a graphical map of skin conditions may be created and updated as required. The condition, with a location specific address and identifier, is categorized with a menu-driven method. The dermatologist enters characteristics of the condition by either selecting available choices or typing them into the system directly.

The next step in the OSAP workflow method is the subjective phase. In this phase, the dermatologist discusses the history of any present illness (e.g. any skin condition) with the patient. The dermatologist may then enter the patient's data into the system and use it to compliment existing data.

The third step in the OSAP workflow method is the assessment phase. The system enables the dermatologist to analyze a condition faster and easier than paper methods or competing systems. Using the combination of characteristics, the system then provides decision support for the dermatologist. Decision support enables the dermatologist to select a diagnosis from a targeted list based upon skin condition or manually type in skin condition. The dermatologist then chooses a diagnosis from the available choices or manually enters one.

The final step in the OSAP workflow method is the plan phase. The system enables the dermatologist to plan a response faster and easier than paper methods or competing systems. The system suggests possible treatments for a chosen diagnosis. In addition, common prescriptions and dosages are recommended. The system may also link to prescription providers to make it easier for the dermatologist to write and authorize prescriptions.

A key element of the system is the graphical interface. The graphical interface is tied to all of the other elements to enable a visual workflow for the dermatologist. The skin condition and it's location may be referenced during any of the OSAP steps since popup menu-driven boxes are linked to each identifier.

The graphical interface enables the dermatologist to record a location specific condition in the system. In one embodiment, vertical (y) and horizontal (x) pixel address coordinates are used. The coordinates are relative to the template used, not the screen resolution. Then, the coordinates are scaled to match the relative pixel density of the screen being used. It is possible to have many different templates for a specific skin area, each corresponding to a different pixel density.

One embodiment enables depth (z) axis pixel coordinates to be used. This embodiment would enable three-dimensional recording of skin conditions.

Multiple templates of skin areas are possible representing variations such as male, female, child, adult, weight, height, or other attributes.

Additional embodiments include pre-set pixel densities which enable the dermatologist to zoom-in or zoom-out of a skin area.

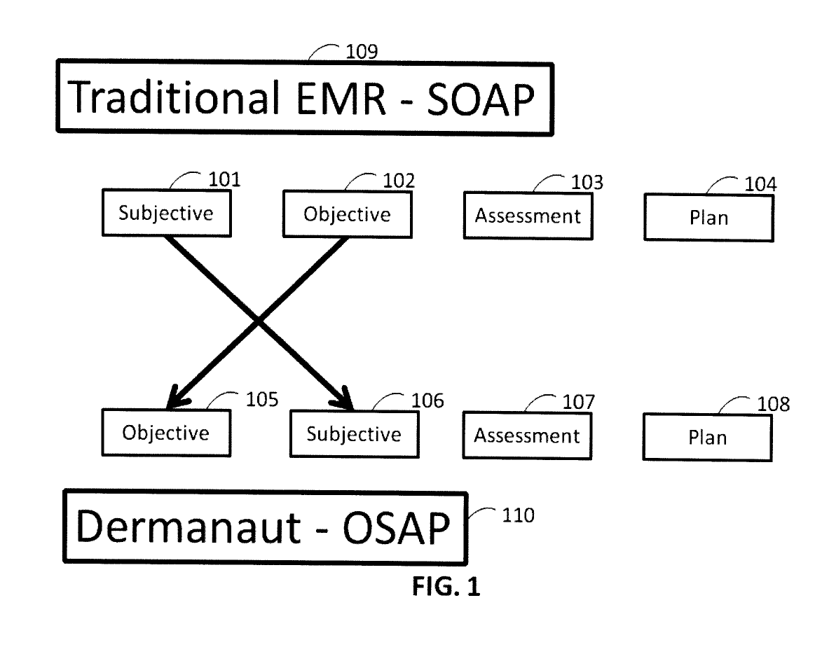

FIG. 1 is a diagram which compares the SOAP 109 to OSAP 110 workflow methods. Most competing EMR systems use the SOAP 109 workflow method. With the SOAP 109 method, the first step is to get subjective 101 information from the patient. Next, the health professional provides an objective 102 opinion of the condition. This may include testing, observation, or further questioning of the patient. Third, an assessment 103 of the condition is made which utilizes the subjective 101 and objective 102 information. Finally, a plan 104 is determined based upon the assessment 103. The plan 104 may include treatment, a prescription for medicine, or further study.

In contrast to SOAP 109, the first step in the Dermanaut OSAP 110 workflow method is an objective opinion 105 from the dermatologist. This may include testing, observation, or further questioning of the patient. Next, the dermatologist gets subjective 106 information from the patient. Third, an assessment 107 of the condition is made which utilizes the subjective 106 and objective 105 information. Finally, a plan 108 is determined based upon the assessment 107. The plan 108 may include treatment, a prescription for medicine, or further study.

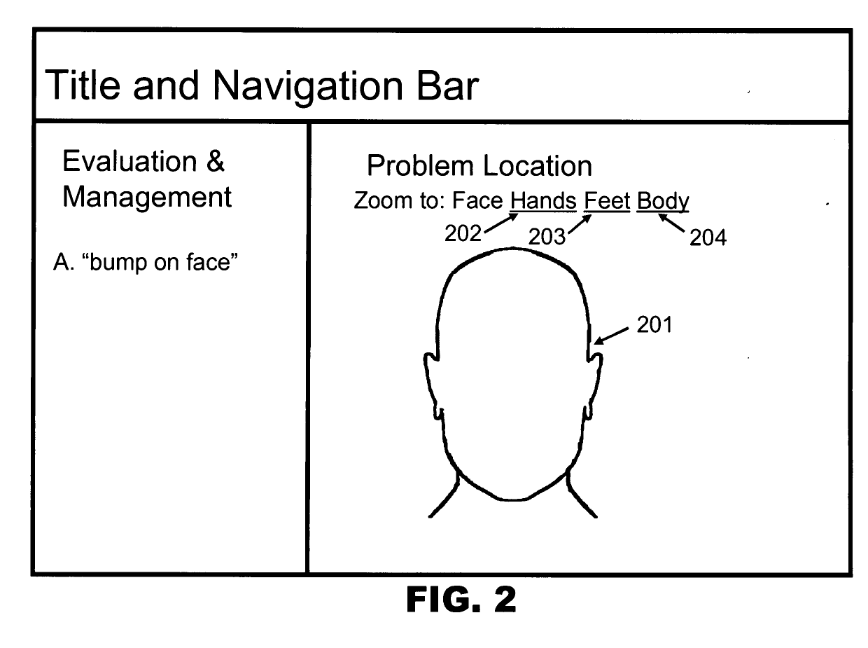

FIG. 2 is a screen shot which shows a new patient encounter. The screen shot provides a graphical depiction of skin in the facial area 201. Other areas of the body may be depicted such as the hands 202, feet 203, and body 204. The depicted areas of the body represent all of a patient's available skin. Further subclassification of skin areas may be available in other embodiments of the system.

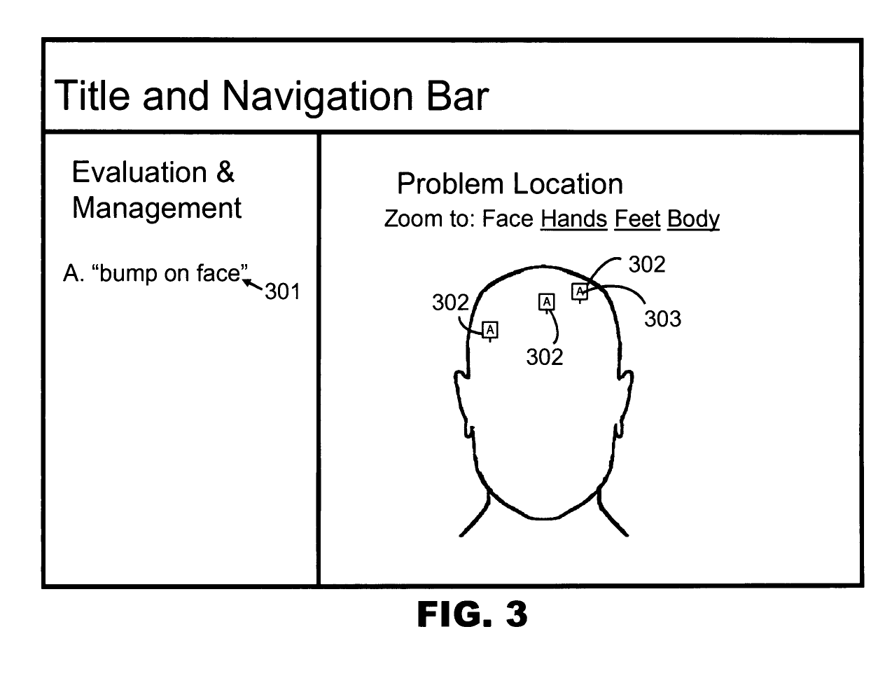

FIG. 3 is a screen shot which shows multiple skin conditions from a patient encounter. Each condition 301 has an associated location(s) 302 with a pixel address and an associated identifier(s) 303.

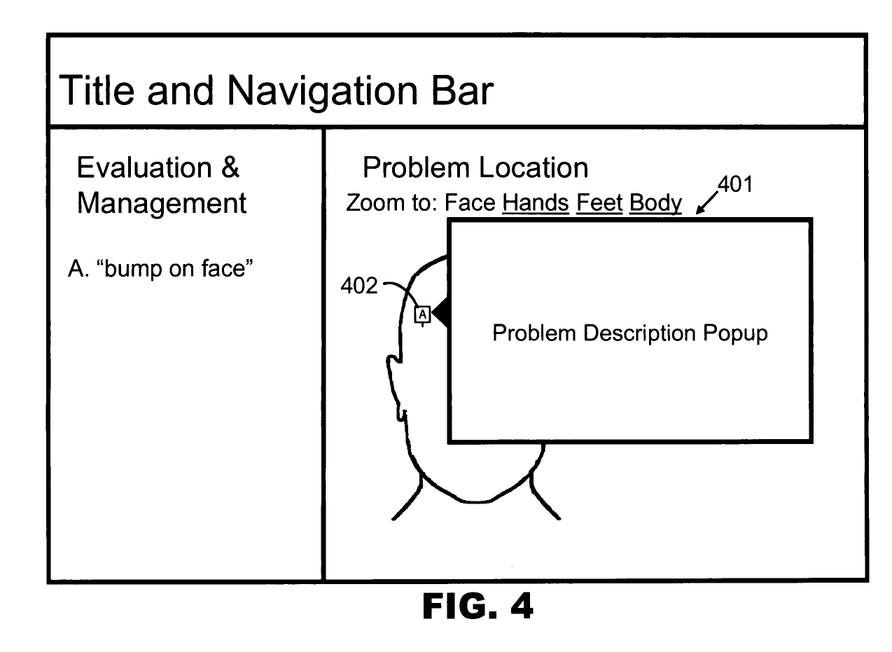

FIG. 4 is a screen shot which shows a mouse-over popup with the details of a particular skin condition. The popup 401 is visible when the dermatologist scrolls a cursor over the identifier 402. The popup 401 contains information relevant to the skin condition.

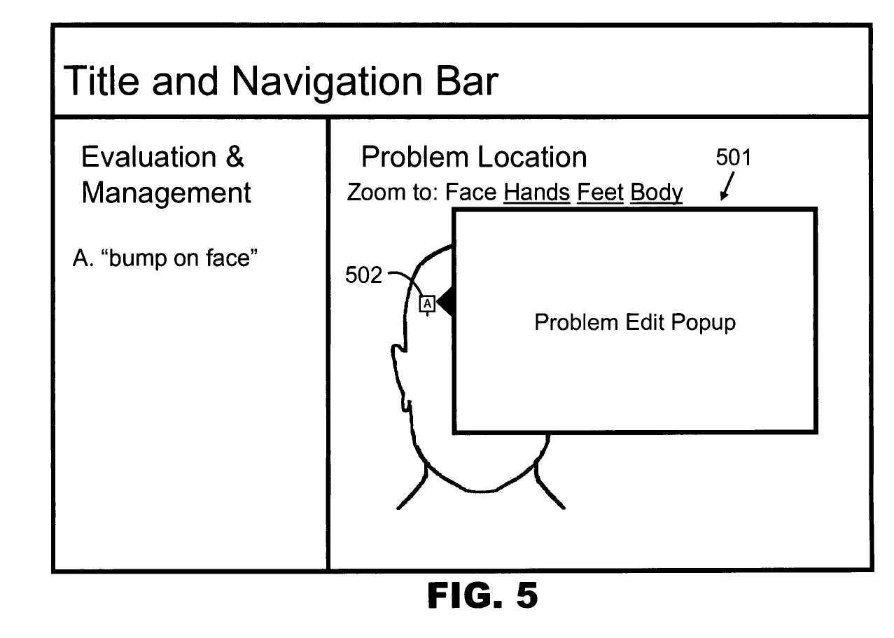

FIG. 5 is a screen shot which shows an edit screen for a skin growth. The edit screen 501 is linked to the identifier 502. The edit screen 501 may be accessed with either a mouse or keyboard command. The edit screen 501 contains information relevant to the skin condition.

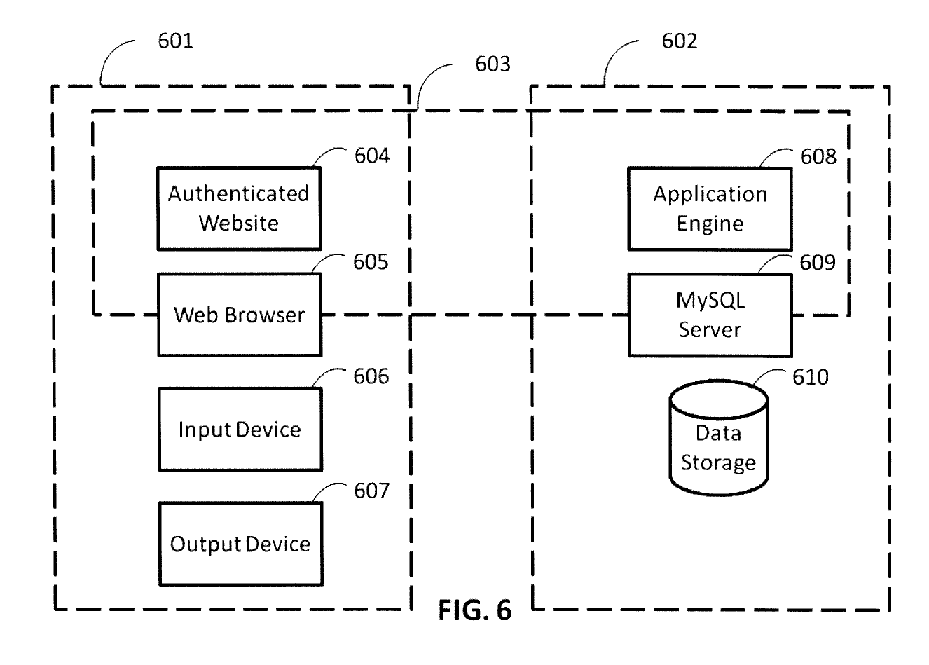

FIG. 6 is a network diagram. Local elements 601 are typically in the dermatologist's office. Remote elements 602 may be located elsewhere. Communications 603 are established between the local elements 601 and remote elements 602. A security protocol 604 is used to authenticate the local elements 601 with the remote elements 602. The typical local element 601 used for initiating and continuing communication is a web browser 605. The typical remote element 602 used for initiating and continuing communication is a server 609. One embodiment of a server is a computer system with software such as MySQL. The server 609 contains the software application engine 608 used to provide software applications. The server 609 also links to data storage 610 where information is stored.

A dermatologist inputs data into the system via an input device 606. Embodiments of an input device 606 include a tablet PC, netbook PC, laptop PC, and desktop PC. Associated peripherals are also included. Examples of peripherals are a mouse, trackball, keyboard, touchscreen, and mousepad.

A dermatologist reads data and information via an output device 607. Embodiments of an output device 607 include a tablet PC, netbook PC, laptop PC, and desktop PC. Associated peripherals are also included. Examples of peripherals are a touchscreen, monitor, LCD display, and the like.

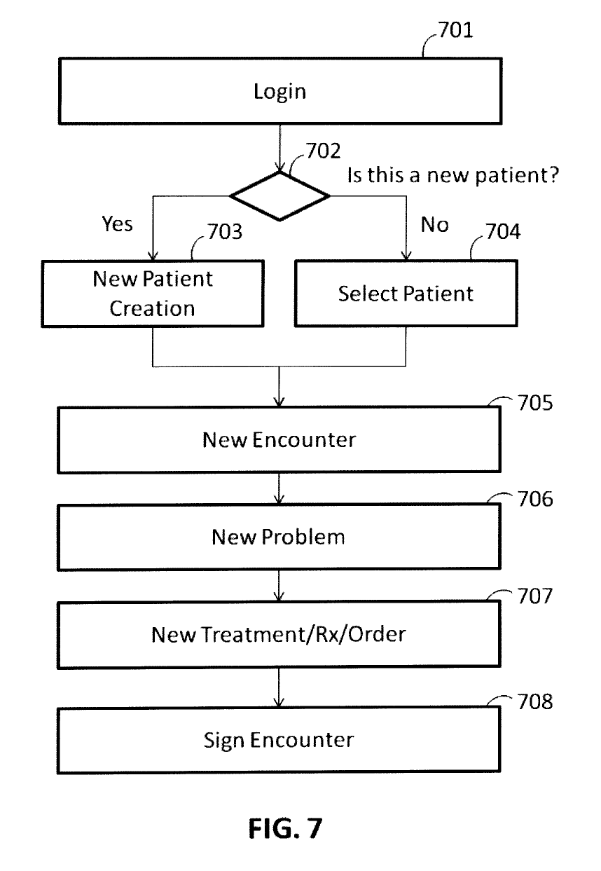

FIG. 7 is a flowchart illustrating a method for providing patient services. A dermatologist uses the system login 701 procedure to begin. Next, the dermatologist determines whether or not he has a new patient 702. If the dermatologist has a new patient 702, the new patient creation 703 procedure is followed. Information is input into the system for the new patient. If the dermatologist does not have a new patient, he uses the select patient 704 function of the system to retrieve existing information related to the patient. Next, a new encounter 705 template is opened for the system. The dermatologist then identifies a new problem 706 and enters relevant data into the system. Previously identified and stored problems may also be accessed from the system. The dermatologist next performs the new treatment/Rx/order 707 step. In this step, the dermatologist decides on a treatment for the skin condition, authorizes a prescription, and then decides if an additional skin condition should be investigated (i.e. go back to step 706). If there are no other skin conditions to investigate, the dermatologist performs the sign encounter 708 step to authenticate the electronic medical record and save it in the system.

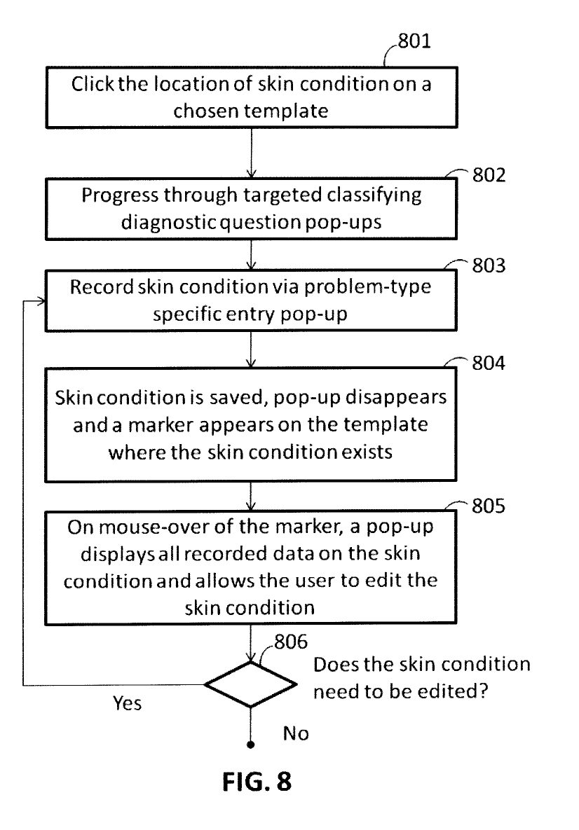

FIG. 8 is a flowchart illustrating a method for recording a skin condition. A dermatologist begins by clicking on the location of a skin condition using a chosen template 801. Then, the dermatologist progresses through a series of targeted classifying diagnostic question pop-ups 802. Next, the dermatologist records the skin condition via a problem-type specific entry pop-up 803. Then, the skin condition is saved, the pop-up disappears, and a marker appears on the template where the skin condition exists 804. When a mouse-over of the marker occurs, a pop-up displays all recorded data on the skin condition and allows the user to edit the skin condition 805. Next, the dermatologist determines if information for the skin condition needs to be edited 806. If an edit is required, the dermatologist goes back to step 803. If an edit is not required, then the dermatologist is done recording the skin condition.

When a prototype of the system was tested, unexpected results occurred. The unexpected results included shorter patient visits, better record keeping, and fewer prescription errors. In part, the shorter patient visits occurred because of the integration of templates, mouse-over pop-ups, and editing functions within the graphical interface.

“Mouse-over” as used herein, means moving a cursor, pointer, or the like over an area within a template. The cursor or pointer is moved via an input device such as a mouse, trackball, mousepad, keyboard, thumb-eraser, or the like. If a touchscreen is being used, any item used to touch the screen may be used to create the mouse-over.

In one embodiment, the system may be implemented in a non-networked setting. That is, the system consists of a server/client model.

Various embodiments of the present subject matter can be implemented in software, which may be run in the environment shown in FIG. 6 or in any other suitable computing environment. The embodiments of the present subject matter are operable in a number of general-purpose or special-purpose computing environments. Some computing environments include personal computers, server computers, hand-held devices (including, but not limited to, telephones and personal digital assistants (PDAs) of all types), laptop devices, multi-processors, microprocessors, set-top boxes, programmable consumer electronics, network computers, minicomputers, mainframe computers, distributed computing environments, and the like to execute code stored on a computer readable medium. The embodiments of the present subject matter may be implemented in part or in whole as machine-executable instructions, such as program modules that are executed by a computer. Generally, program modules include routines, programs, objects, components, data structures, and the like to perform particular tasks or to implement particular abstract data types. In a distributed computing environment, program modules may be located in local or remote storage devices.

A general computing device, in the form of a computer, may include a processor, memory, removable storage, non-removable storage, bus, and a network interface.

A computer may include or have access to a computing environment that includes one or more user input modules, one or more user output modules, and one or more communication connections such as a network interface card or a USB connection. The one or more output devices can be a display device of a computer, computer monitor, TV screen, plasma display, LCD display, display on a digitizer, display on an electronic tablet, and the like. The computer may operate in a networked environment using the communication connection to connect one or more remote computers. A remote computer may include a personal computer, server, router, network PC, a peer device or other network node, and/or the like. The communication connection may include a Local Area Network (LAN), a Wide Area Network (WAN), and/or other networks.

Memory may include volatile memory and non-volatile memory. A variety of computer-readable media may be stored in and accessed from the memory elements of a computer, such as volatile memory and non-volatile memory, removable storage and non-removable storage. Computer memory elements can include any suitable memory device(s) for storing data and machine-readable instructions, such as read only memory (ROM), random access memory (RAM), erasable programmable read only memory (EPROM), electrically erasable programmable read only memory (EEPROM), hard drive, removable media drive for handling compact disks (CDs), digital video disks (DVDs), diskettes, magnetic tape cartridges, memory cards, memory sticks, and the like. Memory elements may also include chemical storage, biological storage, and other types of data storage.

“Processor” or “processing unit” as used herein, means any type of computational circuit, such as, but not limited to, a microprocessor, a microcontroller, a complex instruction set computing (CISC) microprocessor, a reduced instruction set computing (RISC) microprocessor, a very long instruction word (VLIW) microprocessor, an explicitly parallel instruction computing (EPIC) microprocessor, a graphics processor, a digital signal processor, or any other type of processor or processing circuit. The term also includes embedded controllers, such as generic or programmable logic devices or arrays, application specific integrated circuits, single-chip computers, smart cards, and the like.

Embodiments of the present subject matter may be implemented in conjunction with program modules, including functions, procedures, data structures, application programs, etc. for performing tasks, or defining abstract data types or low-level hardware contexts.

While the disclosure describes embodiments and various alternatives thereto, it should be apparent that the invention is not limited to such embodiments. Rather, many variations would be apparent to persons of skill in the art without departing from the scope and spirit of the invention, as defined herein and in the claims.

The invention claimed is:

1. An electronic medical records (EMR) system for dermatology comprising:
a graphical user interface configured to receive input data from a health professional, the graphical user interface comprising:
a series of templates which represent different skin areas;
means to identify a location on a specific template which corresponds to the location of a skin condition;
means to create an identifier for the location on the specific template;
an ability to show relevant data when a cursor is placed over the identifier;
an ability to edit information linked to the identifier; and
an ability to provide suggested treatment for the skin condition which is linked to the identifier.

2. The system of claim 1 wherein the templates reside on one or more servers.

3. The system of claim 2 wherein the templates may be accessed remotely.

4. The system of claim 3 wherein an electronic medical record is automatically generated.

5. A method for generating an electronic medical record for use in dermatology, the method comprising the steps of:
having a health professional make an objective assessment of a patient condition;
entering the objective assessment into an electronic medical records (EMR) system, the EMR system comprising:
a graphical user interface configured to receive input data from a health professional, the graphical user interface comprising:
a series of templates which represent different skin areas;
means to identify a location on a specific template which corresponds to the location of a skin condition;
means to create an identifier for the location on the specific template;
an ability to show relevant data when a cursor is placed over the identifier;
an ability to edit information linked to the identifier;
an ability to provide suggested treatment for the skin condition which is linked to the identifier;
entering a subjective assessment from the patient into the EMR system;
analyzing the objective and subjective assessments; and
formulating a treatment plan.

6. The system of claim 5 wherein the templates reside on one or more servers.

7. The system of claim 6 wherein the templates may be accessed remotely.

8. The system of claim 7 wherein an electronic medical record is automatically generated.
